(19) United States
(12) Patent Application Publication
(10) Pub. No.: US 2026/0327748 A1
(43) Pub. Date: Oct. 22, 2026

(54) DEVICE FOR PRODUCING COPPER WITH AN IMPROVED CO2 BALANCE

(71) Applicant: SMS GROUP GMBH, Mönchengladbach (DE)

(72) Inventors: Stephan GEIMER, Mülheim an der Ruhr (DE); Rolf DEGEL, Ratingen (DE); Tim LUX, Meerbusch (DE); Frank KAUSSEN, Aachen (DE); Nikolaus BOROWSKI, Düsseldorf (DE); Markus REUTER, Düsseldorf (DE)

(21) Appl. No.: 19/109,881

(22) PCT Filed: Sep. 7, 2023
(86) PCT No.: PCT/EP2023/074527

§ 371 Date: Mar. 7, 2025

(30) Foreign Application Priority Data
Sep. 7, 2022 (DE) 10 2022 122 729.4

(51) Int. Cl. C22B 15/00

(52) U.S. Cl. CPC C22B 15/0095; C22B 15/005; C22B 15/0052

(57) ABSTRACT

A device for the pyrometallurgical CO2-neutral production of copper from a copper-containing starting material is disclosed. According to the disclosure, during the melting and/or reduction process, a hydrogen-containing gas is supplied in such a quantity that the steam content in the exhaust gas lies within a specified target value range.

The present invention relates to a device for the pyrometallurgical production of high-purity copper from a copper-containing starting material. The device has an improved CO₂ balance and/or is a device for CO₂-neutral production of high-purity copper or a high-purity copper product. Furthermore, the present invention relates to a method for producing high-purity copper or a high-purity copper product, in particular using the device according to the invention, as well as to the use of the device according to the invention.

High-purity copper is mainly produced via two routes. On the one hand, through the extraction and further processing of copper ore (primary production), and on the other hand, for example, through the recycling of copper-containing scrap, end-of-life products or production residues (secondary production).

In systems known from the prior art, the melting units are usually operated with fossil burners, with natural gas, oil, etc. being used as energy sources. The subsequent refining is also carried out using (blowing in) fossil-fuel energy sources, e.g., natural gas, into the refining furnaces. When these fossil fuels are burned, a large quantity of CO₂ is produced, which is ultimately released into the atmosphere. This is included in the overall balance of the production facility and can account for a significant proportion.

The present invention is based on the object of providing a device which improves copper production with an improved CO₂ balance.

The object underlying the present invention is achieved by a device having the features of claim 1 and a method according to claim 9. Further preferred embodiments are described in the dependent claims.

More specifically, the object underlying the present invention is achieved by a device which is suitable and/or configured for producing copper with a purity of at least 95% from a copper-containing starting material, wherein the device has at least one melting unit for producing a liquid first copper-containing intermediate product and at least one conversion unit for producing a second liquid copper-containing intermediate product from the first copper-containing intermediate product. The device further comprises a supply means which is configured to supply an adjustable volume flow of a hydrogen-containing gas into the melting unit and/or the conversion unit, and wherein the hydrogen-containing gas is selected from the group consisting of H₂, NH₃, an H₂-inert gas mixture, or mixtures of H₂ or NH₃ with CH₄. The inert gas can be argon (Ar) or, preferably, nitrogen (N₂). According to the invention, the volume flow of the hydrogen-containing gas into the melting unit and/or the conversion unit, which is set by means of the supply means, is such that the steam content in the exhaust gas of the melting unit and/or the conversion unit is within a specified target value range. The steam content can be the absolute steam content. The steam content can preferably be a process parameter during the ongoing operation of the relevant unit under consideration.

In particular, it can be the steam content that arises in the stationary phase of the process taking place in the unit under consideration.

The device according to the invention for producing copper can also be referred to as a device for purifying copper, in particular as a device for purifying copper from a copper-containing starting material.

One of the core ideas of the present invention lies in the use of a hydrogen-containing gas to provide the necessary reaction energy and in particular for the targeted control of the oxygen partial pressure in the melting unit and in particular in the conversion unit in which the refining takes place. According to the invention, the supply of hydrogen-containing gas can be adjusted via the steam content in the exhaust gas of the melting unit and/or the conversion unit in such a way that the process is as energy-efficient as possible. On the one hand, this reduces or even completely prevents the use of conventional fossil fuels. On the other hand, it ensures that the process in the melting unit and/or conversion unit takes place with an optimized supply of the hydrogen-containing gas. In both cases, this leads to an improved CO₂ balance.

It has been found that—in order to ensure a process that is as energy efficient as possible—the specified target value range of the steam content in the exhaust gas from the melting unit and/or conversion unit is specific to the relevant unit under consideration.

The device according to the invention can be suitable and/or configured for producing copper with a purity of ≥95%, ≥97%, ≥98.2% or ≥98.9%. Preferably, the copper produced can be in liquid or solid form. The copper proportions indicated can preferably be percentages by weight (wt. %). In particular, the first or second intermediate product which can be produced using the device according to the invention can be in liquid form, i.e., a liquid state of matter. If, as described below, the state of matter is not changed during the conversion of the first intermediate product into the second intermediate product, the production process is advantageously further optimized in terms of energy consumption and thus the CO₂ balance improved. In other words, according to the invention, the first copper-containing intermediate product can be converted into the second copper-containing intermediate product by means of the device without changing the state of matter, in particular the liquid state of matter.

The copper-containing starting material can be any suitable copper-containing material. In particular, the copper-containing starting material can be a copper-containing starting material in the solid state of matter. Furthermore, the copper-containing starting material can be copper concentrate and/or copper scrap or the copper-containing starting material can contain copper concentrate and/or copper scrap. The copper concentrate can have a copper content of ≥10% and ≤40%, preferably ≥15% and ≤35%. The copper concentrate can be so-called “low-grade,” “medium-grade” or “high-grade” copper scrap, in particular scrap according to the WEEE Directive (EU Directive 2012/19/EU). The copper-containing starting material can have a copper content in a range of ≥10% and ≤99%, ≥35% and ≤99%, or ≥81% and ≤98%.

The device according to the invention has at least one melting unit. The melting unit can be suitable and/or configured to produce a liquid first copper-containing intermediate product. The melting unit can be suitable and/or configured to produce a first copper-containing intermediate product, which is in liquid form, from the solid copper-containing starting material.

The melting unit can be any suitable melting unit known to a person skilled in the art. In particular, the melting unit can be suitable and/or configured to melt or liquefy the solid copper-containing starting material. The melting unit has a volume that can accommodate the copper-containing starting material or the first copper-containing intermediate product. The melting unit can further be suitable and/or configured to separate the first liquid copper-containing intermediate product from undesirable materials, for example in the form of slag, from the copper-containing starting material. The melting unit can further be suitable and/or configured to oxidize some accompanying elements contained in the copper-containing starting material, in particular S, C, Al, Zn, Pb, Sn, Ni, Co, As and/or Fe, which separate from the melt through a slag or gas phase. For this purpose, the melting unit can have a supply means for oxygen-containing gas. The melting unit can further be suitable and/or configured to carry out a pyrometallurgical extraction, in particular a two-phase pyrometallurgical extraction, of the copper from the copper-containing starting material.

The melting unit can in particular be selected from the group consisting of a bath melter, an arc furnace, in particular an EAF (electric arc furnace) or an SAF (submerged arc furnace), an induction furnace, a TBRC (top blown rotary converter); also known as “Kaldo converter”), a TRF (tilting refining furnace), an ETRF (elliptical tilting refining furnace) and a ladle furnace.

The bath melter can have a gas burner as a supply means and, in addition, a top lance for the supply of oxygen and/or hydrogen-containing gas. The bath melter can further comprise laterally arranged nozzles for introducing oxygen and/or hydrogen-containing gas into the volume of the bath melter.

The EAF or SAF can have as heating device a heating device for generating an (open) arc furnace. In addition, the EAF or SAF can have gas burners as a supply means.

The induction furnace can comprise an inductive heater, in particular an induction coil arranged around the crucible.

The TBRC can have a gas burner as a supply means and, in addition, a top lance as a supply means for the supply of oxygen-containing and/or hydrogen-containing gas.

The TRF or ETRF can have a gas burner, in particular a front wall burner, as a supply means. Furthermore, one or more nozzles can be present for introducing oxygen and/or hydrogen-containing gas into the volume of the TRF or ETRF. These nozzles of the TRF or ETRF can be designed in such a way that they can be rotated under the bath.

The ladle furnace can have a gas burner as a supply means and/or an electrically operated heating device. Furthermore, the ladle furnace can have a top lance as a supply means for the supply of oxygen and/or hydrogen-containing gas.

The first copper-containing intermediate product can have a copper content of ≥70%, preferably ≥75% and ≤99.8%, preferably ≤99.5%. The first copper-containing intermediate product can further have an oxygen content of ≤6000 ppm, preferably ≤4000 ppm.

The first copper-containing intermediate product can have a temperature of ≥1100 °C and ≤1400 °C, preferably ≥1150 °C and ≤1350 °C This temperature can be present in particular if the first copper-containing intermediate product has the copper content described above. This copper content of the first copper-containing intermediate product can also be referred to as the target copper content of the first copper-containing intermediate product. This temperature can also be present before the first copper-containing intermediate product is transferred to the conversion unit and/or when the first copper-containing intermediate product leaves the melting unit.

The device according to the invention has at least one conversion unit. The conversion unit can be suitable and/or configured to produce a second copper-containing intermediate product, which is in liquid form, from the first liquid copper-containing intermediate product. The conversion unit has a volume that can accommodate the first or second copper-containing intermediate product.

The conversion unit can be any suitable conversion unit known to a person skilled in the art. The conversion unit can also be referred to as a refining unit, in particular a pyrolytic refining unit. In particular, the conversion unit can be suitable and/or configured to reduce and/or oxidize the liquid first copper-containing intermediate product in order to produce the second liquid copper-containing intermediate product. Preferably, the conversion unit is at least suitable and/or configured to reduce the liquid first copper-containing intermediate product. Also preferably, the conversion unit is suitable and/or configured to first oxidize the liquid first copper-containing intermediate product and then to reduce it.

The conversion unit can be suitable and/or configured to increase the oxygen partial pressure in the first liquid copper-containing intermediate product. This allows the liquid first copper-containing intermediate product to be oxidized. This can be achieved, for example, by supplying oxygen carriers such as air and/or O₂. For this purpose, the conversion unit can have a supply means for an oxygen carrier. By increasing the oxygen partial pressure in the first liquid copper-containing intermediate product, further components thereof, in particular Pb, Sn, Ni, Sb, Zn, Ni, Co, As, Fe, can be oxidized and thereby slagged, which leads to further purification. These components are substantially elements with a higher affinity for oxygen than copper, but copper is also oxidized.

The conversion unit can additionally or alternatively be suitable and/or configured to reduce the oxygen partial pressure in the first liquid copper-containing intermediate product. This allows the liquid first copper-containing intermediate product to be reduced.

This can be achieved according to the invention by supplying the hydrogen-containing gas selected from the group consisting of H₂, NH₃, or mixtures of H₂, CH₄ and/or NH₃. For this purpose, the conversion unit can have a supply means for the hydrogen-containing gas.

The conversion unit can in particular be selected from the group consisting of a DSC (Peirce-Smith converter), a ladle furnace, an anode furnace, a TBRC, a TRF and an ETRF.

The PSC can comprise a gas burner, in particular a front wall burner. Furthermore, one or more nozzles can be present for introducing oxygen-and/or hydrogen-containing gas into the volume of the PSC. These nozzles of the PSC can be designed in such a way that they can be rotated under the bath.

The anode furnace can have a gas burner, in particular a front wall burner. Furthermore, one or more nozzles can be present for introducing oxygen-and/or hydrogen-containing gas into the volume of the anode furnace. These nozzles of the anode furnace can be designed in such a way that they can be rotated under the bath.

The melting unit and the conversion unit can be identical units. This can be particularly the case with the TBRC, the TRF, the ETRF and the ladle furnace. This achieves several advantages. In particular, no transfer of the first copper-containing intermediate is necessary, which saves energy to counteract cooling of the first copper-containing intermediate product.

The device according to the invention can be suitable and/or configured to provide the second liquid copper-containing intermediate product without allowing the first copper-containing intermediate product to change from the liquid to the solid state of matter. In other words, the device can be suitable and/or configured to carry out a transfer of the first copper-containing intermediate product from the melting unit to the conversion unit, wherein the first copper-containing intermediate product retains its liquid state of matter.

The device can be suitable and/or configured to maintain the temperature of the liquid first copper-containing intermediate product above the melting point of the first copper-containing intermediate product. This can be achieved by ensuring that the melting unit and the conversion unit are identical units, as described above. Otherwise, the device can comprise a transfer means for transferring the liquid first copper-containing intermediate product from the melting unit to the conversion unit. This transfer means can have a heating device, for example an electrically operated heater and/or a gas burner. Alternatively or additionally, the transfer means can also be thermally insulated, for example by a cover. The transfer means can, for example, be constituted by channels and/or ladles.

The melting unit and/or the conversion unit can have at least one heating device, in particular at least one additional heating device. An “additional” heating device means that there is an additional heating device in addition to the heating device already included as standard in the melting unit and/or conversion unit. For example, an induction furnace has an induction heater, for example an induction coil arranged around the crucible, or an arc furnace always has an arc heater. According to the invention, the unit can then have at least one further heating device in addition to this known heating device.

Preferably, the heating device, in particular the additional heating device, can be an electrically operated heating device and/or a burner, in particular a gas burner.

If the heating device or the additional heating device has a gas burner, this can be identical to the supply means according to the invention for supplying a hydrogen-containing gas into the melting unit and/or the conversion unit, or it can be different therefrom, i.e., it can be formed by an independent assembly.

The electrically operated heating device can preferably be operated with electrical energy from renewable sources. Conversely, the device according to the invention can be suitable and/or configured to operate the electrically operated heating device with electrical energy from renewable sources. This advantageously results in a further improved CO₂ balance being achieved. The term “electrical energy from renewable sources” can be used to describe CO₂-neutrally supplied electrical energy and/or “green electricity.” Electrical energy from renewable sources includes, for example, electrical energy from hydropower, biomass, biogas, geothermal energy, wind power and/or photovoltaics.

The electrically operated heating device can be selected from the group consisting of an electrically operated radiant heater, an electrically operated convection heater, a resistance heater, an inductive heater, an arc heater and combinations thereof. Preferably, the heating device can be designed as an inductive heater and/or arc heater, even more preferably the heating device can be designed as an inductive heater.

The gas burner can preferably be operated with a hydrogen-containing gas produced from renewable sources. Conversely, the device can be suitable and/or configured to operate the gas burner with a hydrogen-containing gas produced from renewable sources.

This also advantageously results in a further improved CO₂ balance being achieved. The term “hydrogen-containing gas produced from renewable sources” can be used to describe CO₂-neutrally supplied hydrogen-containing gas and/or “green gas.” An example of this is hydrogen produced by splitting water using electrolyzers, where the energy required for the electrolysis was completely covered by renewable energies such as wind energy, geothermal energy or solar energy.

In the case of an induction furnace or an arc furnace, the heating device of the melting unit can preferably be an additional non-electrically operated heating device, in particular a gas burner. The melting unit then has at least one electrical heating device and at least one non-electrical heating device, in particular a gas burner. In the case of a bath melter, a TBRC, a TRF or an ETRF, the heating device of the melting unit can preferably be an additional electrically operated heating device, in particular an induction heater. The melting unit then has at least one non-electrical heating device and at least one electrical heating device, in particular an induction heater.

The heating device of the conversion unit can be an additional electrically operated heating device, in particular an induction heater. The conversion unit then has at least one non-electrical heating device, in particular a gas burner, and at least one electric heating device.

The second copper-containing intermediate product can have a copper content in a range of ≥95.0 and ≤99.9%, preferably ≥98.0 and ≤99.9%, or ≥98.2 and ≤99.8%. The second copper-containing intermediate product can have an oxygen content of ≤2500 ppm, preferably ≤2000 ppm.

The supply means according to the invention can be any suitable supply means known to a person skilled in the art by means of which the hydrogen-containing gas can be supplied or injected into the melting unit and/or the conversion unit. A supply means (for both the hydrogen-and the oxygen-containing gas) can be designed, for example, as a burner, in particular a gas burner and/or a front burner, or can be in the form of a gas lance or an injector. The supply means can comprise a valve, a proportional valve or a step controller.

The supply means can open into the volume of the melting unit and/or the conversion unit (which receives the first or the second copper-containing intermediate product) and/or can be arranged there at least partially or completely. This ensures that the hydrogen-containing gas can be introduced into the melting unit and/or the conversion unit. The supply means can further be fluidically connected to at least one reservoir for the hydrogen-containing gas. In particular, in the case that the hydrogen-containing gas is a gas mixture, several reservoirs with different hydrogen-containing gases can be fluidically connected to the supply means. At least one mixing means for adjusting the gas mixture can be arranged between the reservoirs and the supply means. This (these) reservoir(s) and/or mixing means can be a component of the device according to the invention.

The supply means can comprise a nozzle, in particular a refining nozzle. The supply means can also be selected from the group consisting of a nozzle, in particular a refining nozzle, a gas burner, a lance, in particular a gas lance, a purging stone and an impeller.

Preferably, the hydrogen-containing gas can be a gas mixture, in particular an H₂-inert gas mixture or, more preferably, a gas mixture of H₂ or NH₃ with CH₄. A gas mixture of H₂ with CH₄ is particularly preferred here. Advantageously, the CO₂ balance improves with increasing replacement of H₂ and/or NH₃ as an energy source if this means that it is possible to dispense with a carbon-containing energy source, such as CH₄. This applies in particular if the H₂ and/or the NH₃ are gases produced in a “green” way. Also, the hydrogen-containing gas preferably does not contain any carbon. These gas mixtures, in particular the gas mixture consisting of H₂ and CH₄, can have a H₂ proportion (in volume percent) in a range of ≥10% and ≤80%, more preferably ≥25% and ≤70%, ≥25% and ≤50%, even more preferably ≥25% and ≤35%. These gas mixtures, in particular the gas mixture consisting of NH₃ and CH₄, can have an NH₃ proportion (in volume percent) in a range of ≥10% and ≤80%, more preferably ≥25% and ≤70%, ≥25% and ≤50%, even more preferably ≥25% and ≤35%. These proportions of H 2 or NH 3 have proven to be particularly advantageous and therefore suitable for the device according to the invention for producing copper with an improved CO₂ balance.

The gas mixtures of H₂ or NH₃ with CH₄ or the H₂-inert gas mixture can be gas mixtures which contain or consist of the components mentioned.

The supply means can be a controllable supply means, wherein the device is configured to determine the steam content in the exhaust gas of the melting unit and/or the conversion unit and to control the supply means depending on the determined steam content. The term “controllable” means that the quantity of hydrogen-containing gas which is supplied into the melting unit and/or the conversion unit during operation of the device according to the invention is variable over time. In other words, the volume flow of the hydrogen-containing gas into the units and/or the partial pressure of the hydrogen-containing gas in the first or second liquid copper-containing intermediate product can be changed during operation of the device. Such control of the gas flow introduced into the melting unit and/or the conversion unit can be achieved, for example, via controllable valves or step controllers.

The device according to the invention can further be configured to determine the steam content in the exhaust gas of the melting unit and/or the conversion unit. For this purpose, the device can have at least one means for determining the steam content in the exhaust gas of the melting unit and/or the conversion unit. The determination of the steam content in the exhaust gas can preferably be carried out using an FTIR spectrometer. Alternatively or additionally, the steam content can be determined by measuring the oxygen content, the hydrogen content and/or the temperature in the exhaust gas. The device according to the invention and/or the means for determining the steam content can have at least one sensor which is selected from the group consisting of an oxygen sensor, a hydrogen sensor, a temperature sensor or a combination thereof.

The at least one sensor can be arranged at least partially or completely in the exhaust gas volume flow of the melting unit and/or the conversion unit.

A suitable sensor for determining the steam content and/or O₂ content in the exhaust gas can be an FTIR spectrometer. Suitable sensors/probes for temperature measurement can be thermocouples, for example PT100 thermocouples, in particular type K, type S or type B.

The adjustment and/or control of the supply means can be carried out via a computing unit, which can be a component of the device according to the invention. The computing unit can be configured to adjust and/or control the supply means. The computing unit can further be connected to the means for determining the steam content, in particular to at least one or all FTIR spectrometer(s), oxygen sensor(s), hydrogen sensor(s), temperature sensor(s) and combinations thereof. The computing unit can further be configured to determine the steam content in the exhaust gas from the measured values of the sensors, in particular from the measured oxygen content, the hydrogen content and/or the temperature.

As previously stated, the specified target value range of the steam content in the exhaust gas from the melting unit and/or conversion unit is specific to the unit under consideration. These target value ranges, as well as preferred target value ranges, are disclosed below.

The target value for the steam content in the exhaust gas of the melting unit during melting can be in a range of ≥0% and ≤99%, ≥20% and ≤99%, ≥50% and ≤99%, ≥0% and ≤51%, or >0 and ≤5%.

In the case of a bath melter as a melting unit, the target value for the steam content in the exhaust gas during melting can be in a range of ≥15% and ≤80%, preferably ≥15% and ≤45%. Alternatively, in particular in the case of a bath melter having a supersonic injector for the hydrogen-containing gas, the target value during melting can be in a range of ≥40% and ≤99%, preferably ≥80% and ≤99%.

In the case of an arc furnace, in particular an SAF, as a melting unit, the target value for the steam content during melting can be in a range of ≥0% and ≤10%, preferably ≥0% and ≤5%.

In the case of an induction furnace as a melting unit, the target value for the steam content in the exhaust gas during melting can be in a range of ≥0% and ≤10%, preferably ≥0% and ≤5%.

In the case of a TBRC as a melting unit, the target value for the steam content in the exhaust gas during melting can be in a range of ≥40% and ≤99%, preferably ≥80% and ≤99%.

In the case of a TRF or an ETRF as a melting unit, the target value for the steam content in the exhaust gas during melting can be in a range of ≥20% and ≤99%, preferably ≥50% and ≤99%.

In the case of a ladle furnace as a melting unit, the target value for the steam content in the exhaust gas during melting can be in a range of ≥40% and ≤99%, preferably ≥80% and ≤99%.

The target value for the steam content in the exhaust gas of the conversion unit during reduction can be in a range of ≥15% and ≤99%, preferably ≥15% and ≤45%.

In the case of a PSC as a conversion unit, the target value for the steam content in the exhaust gas during reduction can be in a range of ≥20% and ≤99%, preferably ≥50% and ≤99%. If the PSC is used to oxidize the first copper-containing intermediate product prior to reduction, the target value for the steam content during oxidation can be in the range of ≥0% and ≤25%, preferably ≥0% and ≤15%.

In the case of a ladle furnace as a conversion unit, the target value for the steam content in the exhaust gas during reduction can be in a range of ≥15% and ≤45%, preferably ≥15% and ≤35%. If the ladle furnace is used to oxidize the first copper-containing intermediate product before reduction, the target value for the steam content during oxidation can be in a range of ≥0% and ≤25%, preferably ≥0% and ≤15%.

In the case of an anode furnace as a conversion unit, the target value for the steam content in the exhaust gas during reduction can be in a range of ≥15% and ≤45%, preferably ≥15% and ≤35%. If the anode furnace is used to oxidize the first copper-containing intermediate product before reduction, the target value for the steam content in the exhaust gas during oxidation can be in a range of ≥0% and ≤10%, preferably ≥0% and ≤5%.

In the case of a TBRC as a conversion unit, the target value for the steam content in the exhaust gas during reduction can be in a range of ≥15% and ≤45%, preferably ≥15% and ≤35%. If the TBRC is used to oxidize the first copper-containing intermediate product prior to reduction, the target value for the steam content in the exhaust gas during oxidation can be in a range of ≥0% and ≤15%, preferably ≥0% and ≤10%.

In the case of a TRF or an ETRF as a conversion unit, the target value for the steam content in the exhaust gas during reduction can be in a range of ≥15% and ≤45%, preferably ≥15% and ≤35%. If the TRF or the ETRF is used to oxidize the first copper-containing intermediate product prior to reduction, the target value for the steam content in the exhaust gas during oxidation can be in a range of ≥0% and ≤25%, preferably ≥0% and ≤15%.

The device according to the invention can further comprise an anode casting wheel or a granulation means for converting the second copper-containing intermediate product into a third copper-containing intermediate product. The third copper-containing intermediate product can have a solid state of matter. The third copper-containing intermediate product can be copper granulate or a copper anode, each with a copper content of ≥95%. The anode casting wheel can have thermal insulation and/or a heating device, in particular a gas burner, preferably a hydrogen burner.

The device can comprise a transfer means for transferring the liquid second copper-containing intermediate product from the conversion unit into the anode casting wheel or the granulation device. This transfer means can have a heating device, for example an electrically operated heater and/or a gas burner, in particular a hydrogen burner. Alternatively or additionally, the transfer means can be thermally insulated, for example by a cover. The transfer means can, for example, be constituted by channels and/or ladles.

The device can comprise a refining electrolysis unit for the electrolytic conversion of the copper-containing intermediate product, in particular a copper anode. The electrical energy required to carry out refining electrolysis can come from renewable sources. After the refining electrolysis, the copper-containing product, in particular the copper cathode, can have a copper content of ≥99.9%, preferably ≥99.99%.

The device can comprise a unit for leaching and/or hydrometallurgical treatment, as well as a recovery electrolysis unit for the electrolytic conversion of the copper-containing intermediate product, in particular copper granulate. The unit for leaching and/or hydrometallurgical conversion can have a supply means for a hydrogen-containing gas, in particular hydrogen. The hydrogen-containing gas can have been produced from renewable sources. The electrical energy required to carry out recovery electrolysis can come from renewable sources. After the recovery electrolysis, the copper-containing product, in particular the copper cathode, can have a copper content of ≥99.9%, preferably ≥99.99%.

In the following, some particularly preferred combinations of melting unit and conversion unit are disclosed.

Preferably, the device according to the invention can comprise an induction furnace as a melting unit and a TRF or an ETRF as a conversion unit. The volume flow of the hydrogen-containing gas into the induction furnace, which is set by means of the supply means, is such that the steam content in the exhaust gas of the induction furnace when melting the copper-containing starting material is within the specified target value range of ≥0% and ≤10%, preferably ≥0% and ≤5%. The volume flow of the hydrogen-containing gas into the TRF or the ETRF, adjusted by means of the supply means, is such that the steam content in the exhaust gas of the TRF or the ETRF when reducing the first copper-containing intermediate product is within the specified target value range of ≥15% and ≤45%, preferably ≥15% and ≤35%. If the TRF or the ETRF is used in addition to the oxidation of the first copper-containing intermediate product prior to reduction, the target value for the steam content during oxidation can be in a range of ≥0% and ≤25%, preferably ≥0% and ≤15%.

Preferably, the device according to the invention can comprise an induction furnace as a melting unit and a ladle furnace as a conversion unit. The volume flow of the hydrogen-containing gas into the induction furnace, which is set by means of the supply means, is such that the steam content in the exhaust gas of the induction furnace when melting the copper-containing starting material is within the specified target value range of ≥0% and ≤10%, preferably ≥0% and ≤5%. The volume flow of the hydrogen-containing gas into the ladle furnace, adjusted by means of the supply means, is such that the steam content in the exhaust gas of the ladle furnace when reducing the first copper-containing intermediate product is within the specified target value range of ≥15% and ≤45%, preferably ≥15% and ≤35%. If the ladle furnace is used in addition to the oxidation of the first copper-containing intermediate product prior to reduction, the target value for the steam content during oxidation can be in a range of ≥0% and ≤25%, preferably ≥0% and ≤15%.

Preferably, the device according to the invention can have a TRF as a melting unit and as a conversion unit. The volume flow of the hydrogen-containing gas into the TRF, which is set by means of the supply means, is such that the steam content in the exhaust gas of the TRF when melting the copper-containing starting material is within the specified target value range of ≥20% and ≤99%, preferably ≥50% and ≤99%. The volume flow of the hydrogen-containing gas into the TRF, adjusted by means of the supply means, is such that the steam content in the exhaust gas of the ladle furnace when reducing the first copper-containing intermediate product is within the specified target value range of ≥15% and ≤45%, preferably ≥15% and ≤35%. If the TRF is used in addition to the oxidation of the first copper-containing intermediate product prior to reduction, the target value for the steam content during oxidation can be in a range of ≥0% and ≤25%, preferably ≥0% and ≤15%.

Preferably, the device according to the invention can comprise an ETRF as a melting unit and as a conversion unit. The volume flow of the hydrogen-containing gas into the ETRF, which is set by means of the supply means, is such that the steam content in the exhaust gas of the ETRF when melting the copper-containing starting material is within the specified target value range of ≥20% and ≤99%, preferably ≥50% and ≤99%. The volume flow of the hydrogen-containing gas into the ETRF, adjusted by means of the supply means, is such that the steam content in the exhaust gas of the ladle furnace when reducing the first copper-containing intermediate product is within the specified target value range of ≥15% and ≤45%, preferably ≥15% and ≤35%. If the ETRF is used in addition to the oxidation of the first copper-containing intermediate product prior to reduction, the target value for the steam content during oxidation can be in a range of ≥0% and ≤25%, preferably ≥0% and ≤15%.

Preferably, the device according to the invention can comprise a bath melter as a melting unit and a TBRC as a conversion unit. The volume flow of the hydrogen-containing gas into the bath melter, which is set by means of the supply means, is such that the steam content in the exhaust gas of the bath melter when melting the copper-containing starting material is within the specified target value range of ≥15% and ≤80%, preferably ≥15% and ≤45%. In case the bath melter has a supersonic injector, the target value range is ≥40% and ≤99%, preferably ≥80% and ≤99%. The volume flow of the hydrogen-containing gas into the TBRC, adjusted by means of the supply means, is such that the steam content in the exhaust gas of the ladle furnace when reducing the first copper-containing intermediate product is within the specified target value range of ≥15% and ≤45%, preferably ≥15% and ≤35%. If the TBRC is used in addition to the oxidation of the first copper-containing intermediate product prior to reduction, the target value for the steam content during oxidation can be in a range of ≥0% and ≤15%, preferably ≥0% and ≤10%.

Preferably, the device according to the invention can comprise an arc furnace, in particular an EAF or an SAF, as a melting unit and a TRF or an ETRF as a conversion unit. The volume flow of the hydrogen-containing gas into the arc furnace, which is set by means of the supply means, is such that the steam content in the exhaust gas of the arc furnace when melting the copper-containing starting material is within the specified target value range of ≥0% and ≤10%, preferably ≥0% and ≤5%. The volume flow of the hydrogen-containing gas into the TRF or the ETRF, adjusted by means of the supply means, is such that the steam content in the exhaust gas of the TRF or the ETRF when reducing the first copper-containing intermediate product is within the specified target value range of ≥15% and ≤45%, preferably ≥15% and ≤35%. If the TRF or the ETRF is used in addition to the oxidation of the first copper-containing intermediate product prior to reduction, the target value for the steam content during oxidation can be in a range of ≥0% and ≤25%, preferably ≥0% and ≤15%.

Preferably, the device according to the invention can comprise a bath melter as a melting unit and a TRF or an ETRF as a conversion unit. The volume flow of the hydrogen-containing gas into the bath melter, which is set by means of the supply means, is such that the steam content in the exhaust gas of the bath melter when melting the copper-containing starting material is within the specified target value range of ≥15% and ≤80%, preferably ≥15% and ≤45%. In case the bath melter has a supersonic injector, the target value range is ≥40% and ≤99%, preferably ≥80% and ≤99%. The volume flow of the hydrogen-containing gas into the TRF or the ETRF, adjusted by means of the supply means, is such that the steam content in the exhaust gas of the TRF or the ETRF when reducing the first copper-containing intermediate product is within the specified target value range of ≥15% and ≤45%, preferably ≥15% and ≤35%. If the TRF or the ETRF is used in addition to the oxidation of the first copper-containing intermediate product prior to reduction, the target value for the steam content during oxidation can be in a range of ≥0% and ≤25%, preferably ≥0% and ≤15%.

Preferably, the device according to the invention can comprise an arc furnace, in particular an EAF or an SAF, as a melting unit and an anode furnace as a conversion unit. The volume flow of the hydrogen-containing gas into the arc furnace, which is set by means of the supply means, is such that the steam content in the exhaust gas of the arc furnace when melting the copper-containing starting material is within the specified target value range of ≥0% and ≤10%, preferably ≥0% and ≤5%. The volume flow of the hydrogen-containing gas into the anode furnace, adjusted by means of the supply means, is such that the steam content in the exhaust gas of the anode furnace when reducing the first copper-containing intermediate product is within the specified target value range ≥15% and ≤45%, preferably ≥15% and ≤35%. If the anode furnace is used in addition to the oxidation of the first copper-containing intermediate product prior to reduction, the target value for the steam content during oxidation can be in a range of ≥0% and ≤10%, preferably ≥0% and ≤5%.

The second liquid copper-containing intermediate product can be transferred into at least one further unit and further processed into a third copper-containing intermediate product which is in a solid state of matter. Such a unit can preferably be an anode casting wheel or a granulation device. The anode casting wheel can have a heating device which is designed as an electric heater or a gas burner. The heating device can preferably be operated with green gas or green electricity.

A refining electrolysis facility can be connected to the anode casting wheel, which can also preferably be operated with green electricity.

The object underlying the present invention is also achieved by the method according to the invention described below, as well as the use according to the invention of the device according to the invention. In order to avoid repetition, only the key aspects of the invention are explicitly stated again. The described features of the device according to the invention apply equally to the method or the use and vice versa.

The method according to the invention for producing copper or a copper product with a purity of at least 95% comprises the following method steps:
a) providing a copper-containing starting material;
b) melting the copper-containing starting material in a melting unit to produce a first liquid copper-containing intermediate product with a copper content of ≥70%; and
c) reducing the first copper-containing intermediate product in a conversion unit to produce a second copper-containing intermediate product with a copper content of ≥95.

The method according to the invention is further characterized in that during the melting and/or the reduction, a hydrogen-containing gas is supplied into the melting unit and/or the conversion unit, so that the steam content in the exhaust gas of the melting unit and/or the conversion unit is within a specified target value range. The hydrogen-containing gas is selected from the group consisting of H₂, NH₃, an H₂-inert gas mixture, or mixtures of H₂ or NH₃ with CH₄.

The method according to the invention can preferably be carried out using the device according to the invention.

According to the invention, the copper-containing starting material is melted in the melting unit after its provision in step a). It is converted into the first liquid copper-containing intermediate product.

The first liquid copper-containing intermediate product is then converted into the second liquid copper-containing intermediate product in the conversion unit in step b). It should be noted again that in some embodiments the melting unit and the conversion unit can be identical units. During the conversion of the first liquid copper-containing intermediate product into the second liquid copper-containing intermediate product in the conversion unit, at least a reduction of the first liquid copper-containing intermediate product can take place.

During the melting and/or reduction of the first copper-containing intermediate product, the hydrogen-containing gas is supplied into the melting unit and/or the conversion unit. As previously stated, this can in particular be at least one hydrogen-containing gas produced from renewable sources. The supplied hydrogen-containing gas is supplied into the melting unit and/or the conversion unit in such a quantity or at such a volume flow that the steam content in the exhaust gas of the melting unit and/or the conversion unit is within a specified and previously described target value range.

The copper-containing starting material can be at least partially oxidized during melting, i.e., in method step b), by supplying an oxygen-containing gas, in particular O₂ and/or air, via a supply means of the melting unit into the melting unit. During this oxidation, for example, S, C, Al, Zn, Pb, Sn, Ni, Co, As and/or Fe are oxidized in the copper-containing starting material.

As previously described, some of the disclosed conversion units are configured not only to reduce a copper-containing intermediate product but also to oxidize it. Such oxidation is preferably carried out before reduction. The first copper-containing intermediate product can therefore be at least partially oxidized by means of the conversion unit before the reduction, i.e., after method step b) but before method step c). This can also be achieved by supplying an oxygen-containing gas, in particular O₂ and/or air, via a supply means of the conversion unit into the conversion unit. In this oxidation, for example, S, C, Al, Zn, Pb, Sn, Ni, Co, As and/or Fe in the first copper-containing intermediate product are oxidized.

Method step b), i.e., the melting, of the method according to the invention can be carried out until the oxygen content of the first copper-containing intermediate product is ≤6000 ppm. Alternatively or additionally, method step c), i.e., the reduction, of the method according to the invention can be carried out until the oxygen content of the second copper-containing intermediate product is ≤2500 ppm.

Also disclosed is a method for producing copper with a purity of at least 95%, comprising the step of reducing a first copper-containing intermediate product in a conversion unit to produce a second copper-containing intermediate product with a copper content of ≥95%, the method being characterized in that during the reduction a hydrogen-containing gas selected from the group consisting of H₂, NH₃, an H₂-inert gas mixture, or mixtures of H₂ or NH₃ with CH₄ is supplied into the conversion unit so that the steam content in the exhaust gas of the conversion unit is within a specified target value range.

Also disclosed is the use of the device according to the invention, in particular according to one of the device claims, for producing copper with a purity of at least 95% from a copper-containing starting material.

Further advantages, details, and features of the invention can be found below in the described exemplary embodiments. In the figures, in detail:

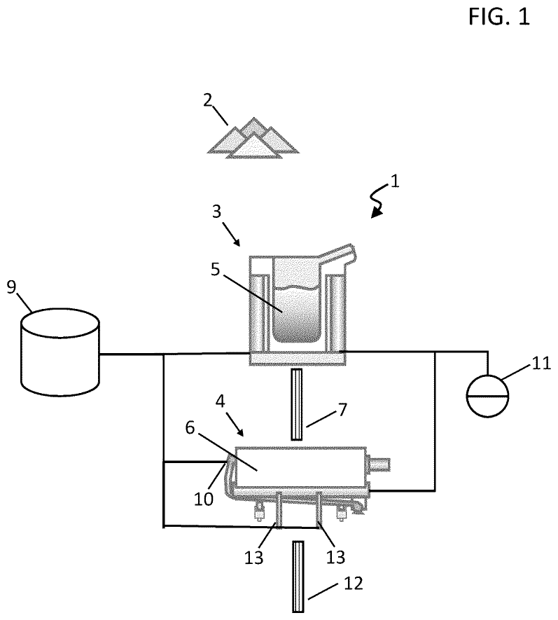

FIG. 1 is a schematic representation of a first embodiment of the device according to the invention with an induction furnace as melting unit and a TRF or ETRF as conversion unit.

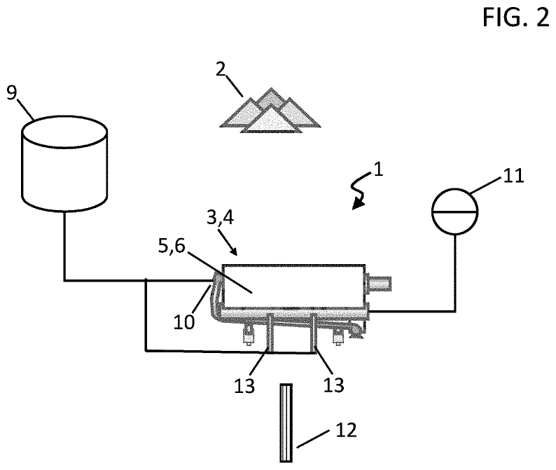

FIG. 2 is a schematic representation of a further embodiment of the device according to the invention with a TRF or an ETRF, which functions both as a melting unit and as a conversion unit.

In the following description, the same reference signs denote the same components or features, such that a description of a component with reference to one figure also applies to the other figures.

FIG. 1 is a schematic representation of a first embodiment of the device 1 according to the invention.

The device 1 comprises a melting unit 3 in the form of an induction furnace, as well as a conversion unit 4 in the form of a tilting refining furnace (TRF). In an alternative embodiment, instead of the TRF an elliptical tilting refining furnace (ETRF) can be used.

In the volume of the induction furnace 3, the first liquid copper-containing intermediate product 5 can be seen, which was produced from the copper-containing starting material 2 in the solid state of matter. The volume of the TRF 4 contains the second liquid copper-containing intermediate product 6 which was produced by oxidation and reduction of the first copper-containing intermediate product 5.

The induction furnace 3 is connected to the TRF 4 by means of the transfer means 7 in the form of a thermally insulated channel. This ensures that the first liquid copper-containing intermediate product 5 can be transferred from the melting unit 3 to the conversion unit 4 without changing its state of matter (liquid). The device 1 according to the invention can have a further transfer means 12, which can also be designed in the form of a channel or ladle. This further transfer means 12 serves to transfer the second liquid copper-containing intermediate product 5 from the conversion unit 4, i.e., the TRF, into at least one additional unit, e.g., an anode casting wheel, for further processing of the copper-containing intermediate product.

The first copper-containing intermediate product has a copper content in the range of ≥75% and ≤99.5%. The second copper-containing intermediate product has a copper content in the range of ≥98.2% and ≤99.8%.

The induction furnace 3 has an electrical heating unit in the form of an induction heater, which is formed by an induction coil arranged around the crucible. The energy supply of the electric heating unit of the induction furnace 3 is provided by the power source 11, which provides electrical energy from renewable sources.

The induction furnace 3 further comprises a supply means (not shown) comprising a gas lance for supplying an adjustable volume flow of a hydrogen-containing gas mixture into the induction furnace. Preferably, this supply means is designed to be controllable and is controlled depending on the steam content in the exhaust gas of the induction furnace. The volume flow of the hydrogen-containing gas mixture through the supply means is adjusted, in particular controlled, in the stationary phase of the melting operation so that the steam content in the exhaust gas of the induction furnace is ≤10% and preferably ≤5%.

The supply means of the induction furnace 3 is connected to a storage or supply connection 9 for the hydrogen-containing gas mixture. The gas mixture is a mixture of CH₄ and H₂ in a ratio of 65:35%, which is also used in the conversion unit 4.

The TRF 4 is also connected to the storage or supply connection 9 for the hydrogen-containing gas mixture and has a supply means 10 via which the hydrogen-containing gas mixture can be introduced into the TRF. The supply means 10 is designed here as a gas burner, in particular as a front wall burner. The TRF 4 can further comprise an additional electrical heating device, which can also be supplied with energy via the power source 11. Furthermore, the TRF has a supply means in the form of 2 to 8 nozzles 13, through which an oxygen-containing gas, preferably O₂ and/or air can be introduced into the volume of the TRF 4. For reduction, hydrogen-containing gas selected from the group consisting of H₂, NH₃, an H₂-inert gas mixture, or mixtures of H₂ or NH₃ with CH₄ can also be introduced via the same nozzles 13.

Preferably, the supply means 10 and 13 of the TRF are designed to be controllable and are controlled depending on the steam content in the exhaust gas of the TRF. The volume flow of the hydrogen-containing gas mixture through the supply means is adjusted, preferably controlled, in the oxidation operation of the TRF so that the steam content in the exhaust gas of the TRF is in a range >0% and <25% and preferably in a range >0% and <20%. In the reduction operation of the TRF following the oxidation operation, however, the volume flow is adjusted, preferably controlled, so that the steam content in the exhaust gas of the TRF is in a range >15% and <45% and preferably in a range >15% and <35%.

FIG. 2 is a schematic representation of a further embodiment of the device 1 according to the invention.

The device 1 has only one TRF, which serves both as a melting unit 3 and as a conversion unit 4. In an alternative embodiment, it is an ETRF that serves both as a melting unit 3 and as a conversion unit 4. The TRF and ETRF correspond to those in FIG. 1. The copper-containing starting product 2 is therefore first converted into the first liquid copper-containing intermediate product 5 in the TRF 4 in its function as a melting unit 3. Subsequently, the first liquid copper-containing intermediate product 5 is converted into the second liquid copper-containing intermediate product 6 in the TRF 4. Accordingly, the transfer means shown in FIG. 1 for transferring the liquid first copper-containing intermediate product 7 is omitted.

The TRF 4 is connected to the storage or supply connection 9 for the hydrogen-containing gas mixture and has a supply means 10 via which the hydrogen-containing gas mixture can be introduced into the TRF. The supply means 10 is designed here as a gas burner, in particular as a front wall burner. The TRF 4 can optionally comprise an additional electrical heating device, which can also be supplied with energy via the power source 11. Furthermore, the TRF has a supply means in the form of 2 to 8 nozzles 13, through which an oxygen-containing gas, preferably O₂ and/or air can be introduced into the volume of the TRF 4. For reduction, hydrogen-containing gas selected from the group consisting of H₂, NH₃, an H₂-inert gas mixture, or mixtures of H₂ or NH₃ with CH₄ can also be introduced via the same nozzles 13.

The gas mixture introduced via the supply means can be a mixture of CH₄ and H₂ in a ratio of 60:40%.

Preferably, the supply means 10 and 13 of the TRF are designed to be controllable and are controlled depending on the steam content in the exhaust gas of the TRF. The volume flow of the gas mixture through the supply means 10 is adjusted, preferably controlled, in the melting operation of the TRF so that the steam content in the exhaust gas of the TRF is in a range ≥20% and ≤99%, preferably ≥50% and ≤99%. The volume flow of the gas mixture through the supply means 13 is adjusted, preferably controlled, in the oxidation operation of the TRF so that the steam content in the exhaust gas of the TRF is in a range ≥0% and ≤25%, preferably ≥0% and ≤15%. In the reduction operation of the TRF following the oxidation operation, however, the volume flow is adjusted, preferably controlled, so that the steam content in the exhaust gas of the TRF is in a range ≥15% and ≤45%, preferably ≥15% and ≤35%.

The device 1 of FIG. 2 can also have a further transfer means 12, which can be designed in the form of a channel or ladle. This transfer means 12 serves to transfer the second liquid copper-containing intermediate product 5 from the conversion unit 4, i.e., the TRF, into at least one additional unit, e.g., an anode casting wheel, for further processing of the copper-containing intermediate product.

### LIST OF REFERENCE SIGNS

1 device for producing copper
2 copper-containing starting material
3 melting unit
4 conversion unit, refining unit
5 liquid first copper-containing intermediate product in the volume of the melting unit
6 liquid second copper-containing intermediate product in the volume of the conversion unit
7 transfer means for transferring the liquid first copper-containing intermediate product; channel or ladle
8 transfer means for transferring the liquid second copper-containing intermediate product; channel or ladle
9 storage or supply connection for hydrogen-containing gas
10 supply means for hydrogen-containing gas into the melting unit and/or the conversion unit, in particular from renewable sources
11 power source; electrical energy from renewable sources
12 transfer means for transferring the liquid second copper-containing intermediate product; channel or ladle
13 supply means for hydrogen-containing gas or air/O₂ into the melting unit and/or the conversion unit, in particular from renewable sources; nozzle

1. A device for producing copper with a purity of at least 95% from a copper-containing starting material, comprising:
at least one melting unit for producing a liquid first copper-containing intermediate product,
at least one conversion unit for producing a second liquid copper-containing intermediate product from the first copper-containing intermediate product, and
at least one supply means which is configured to supply an adjustable volume flow of a hydrogen-containing gas into the melting unit and/or the conversion unit, wherein the hydrogen-containing gas is selected from the group consisting of H₂, NH₃, an H₂-inert gas mixture, or mixtures of H₂ or NH₃ with CH₄,
wherein the volume flow of the hydrogen-containing gas into the melting unit and/or the conversion unit, which is set by means of the supply means, is such that the steam content in the exhaust gas of the melting unit and/or the conversion unit is within a specified target value range.

2. The device according to claim 1, wherein the supply means is a controllable supply means, and wherein the device is configured to determine the steam content in the exhaust gas of the melting unit and/or the conversion unit and to control the supply means depending on the determined steam content.

3. The device according to claim 1, wherein the device is configured to provide the second liquid copper-containing intermediate product without allowing the first copper-containing intermediate product to change from the liquid to the solid state of matter.

4. The device according to claim 1, wherein the melting unit and/or the conversion unit has at least one heating device and at least one additional heating device.

5. The device according to claim 4, wherein the heating device and/or the additional heating device is an electric heating device and/or has a gas burner.

6. The device according to claim 4, wherein the supply means for supplying a hydrogen-containing gas into the melting unit and/or the conversion unit is formed by the heating device.

7. The device according to claim 1, wherein the supply means includes a refining nozzle, and/or is selected from the group consisting of: the refining nozzle, a gas burner, a lance, a purging stone and an impeller.

8. The device according to claim 1, wherein the device has at least one means for determining the steam content; wherein the means is an FTIR spectrometer and/or has an oxygen sensor, a hydrogen sensor, a temperature sensor or combinations thereof.

9. A method for producing copper with a purity of at least 95%, comprising the steps of:
a) providing a copper-containing starting material;
b) melting the copper-containing starting material in a melting unit to produce a first liquid copper-containing intermediate product with a copper content of ≥70%; and
c) reducing the first copper-containing intermediate product in a conversion unit to produce a second copper-containing intermediate product with a copper content of ≥95%,
wherein during melting and/or reduction, a hydrogen-containing gas selected from the group consisting of H₂, NH₃, an H₂-inert gas mixture, or mixtures of H₂ or NH₃ with CH₄ is supplied into the melting unit and/or the conversion unit,
so that the steam content in the exhaust gas of the melting unit and/or the conversion unit is within a specified target value range.

10. The method according to claim 9, wherein the copper-containing starting material is oxidized during melting by supplying an oxygen-containing gas into the melting unit.

11. The method according to either claim 9, wherein the first copper-containing intermediate product is oxidized by means of the conversion unit before the reduction in step b) by supplying an oxygen-containing gas into the conversion unit.

12. The device according to claim 1, wherein the oxygen content of the first copper-containing intermediate product is ≤6000 ppm and/or the oxygen content of the second copper-containing intermediate product is ≤2500 ppm.

13. The device according to claim 1, wherein the copper-containing starting material is selected from the group consisting of copper concentrate, copper scrap or combinations thereof.

14. The device according to claim 1, wherein the melting unit is selected from the group consisting of: bath melter, arc furnace, induction furnace, TBRC, TRF, ETRF and ladle furnace.

15. The device according to claim 1, wherein the conversion unit is selected from the group consisting of: PSC, ladle furnace, anode furnace, TBRC, TRF and ETRF.

16. The device according to claim 1, wherein the hydrogen-containing gas is a mixture of H₂ and CH₄ and an H₂ proportion in a range of ≥10% and ≤80%, or wherein the hydrogen-containing gas is a mixture of NH₃ and CH₄ and an NH₃ proportion in a range of ≥10% and ≤80%.

17. The device according to claim 1, wherein the second copper-containing intermediate product has a copper content in a range of ≥97.0% and ≤99.9%.

18. The device according to claim 1, wherein the target value for the steam content in the exhaust gas of the melting unit is in a range of ≥0% and ≤99%, ≥50% and ≤99%, or ≥0% and ≤5%, and/or
wherein the target value of the steam content in the exhaust gas of the conversion unit during reduction is in a range of ≥15% and ≤45% or ≥15% and ≤35%.

19. The method according to claim 9 for use with a device for producing copper with a purity of at least 95% from a copper-containing starting material, the device comprising:
at least one melting or producing a liquid first copper-containing intermediate product,
at least one conversion unit for producing a second liquid copper-containing intermediate product from the first copper-containing intermediate product, and
at least one supply means which is configured to supply an adjustable volume flow of a hydrogen-containing gas into the melting unit and/or the conversion unit, wherein the hydrogen-containing gas is selected from the group consisting of H₂, NH₃, an H₂-inert gas mixture, or mixtures of H₂ or NH₃ with CH₄,
wherein the volume flow of the hydrogen-containing gas into the melting unit and/or the conversion unit, which is set by means of the is such that the steam content in the exhaust gas of melting unit and/or the conversion unit is within a specified target value range.
